(19) United States
(12) Patent Application Publication
(10) Pub. No.: US 2004/0086353 A1
(43) Pub. Date: May 6, 2004

(54) Bolt and method of retaining a bolt to an engine component

(76) Inventor: Liviu Diaconu, Woodbridge (CA)

Correspondence Address: Robin W. Asher, Clark Hill PLC, Suite 3500, 500 Woodward Avenue, Detroit, MI, 48226-3435, US

(21) Appl. No.: 10/623,985

(22) Filed: Jul. 21, 2003

Related U.S. Application Data
(60) Provisional application No. 60/397,395, filed on Jul. 19, 2002.

(51) Int. Cl. F16B 39/00

(52) U.S. Cl. 411/107

(57) ABSTRACT

A bolt retention assembly comprises a first component defining a hole. The hole has a threaded bore defining a bore diameter and a counter-bore defining a counter-bore diameter greater than the bore diameter. The threaded bore and counter-bore define a relief therebetween. A bolt having a shank portion and a threaded portion extends through the first component wherein the threaded portion is threadingly engageable with the threaded bore and abuttable with the relief to prevent the bolt from being removed from the hole after the threaded portion is rotatably threaded past the threaded bore.

### RELATED APPLICATION

This application claims priority to U.S. Provisional Application Serial No. 60/397,395, filed Jul. 19, 2002.

### FIELD OF THE INVENTION

The invention relates to a bolt and a method of retaining the bolt to an engine component for attaching the component to the engine. More specifically, the invention relates to a bolt configured to be self-retaining in an engine component for assembly to an internal combustion engine.

### DESCRIPTION OF THE RELATED ART

Threaded fasteners are commonly used to integrate a plurality of components or subassemblies into a final assembly. It is known to pre-install and retain these fasteners on the components or subassemblies before integration into the final assembly for increased manufacturing efficiency. Typically, a dedicated retainer in the form of a cardboard or plastic washer is commonly utilized to retain a threaded fastener to the component or subassembly. The pre-installed fastener carried by the component or subassembly is later used to secure the component or subassembly to another component or subassembly eventually resulting in the final assembly.

It remains desirable to provide a threaded fastener and a method of pre-installing and retaining the threaded fastener to a component or subassembly that is subsequently used to secure the component or subassembly in the final assembly.

More specifically, it is desirable to provide a threaded fastener and method of retaining the threaded fastener to an engine component, such as a coolant pump, for subsequent assembly to an internal combustion engine of an automotive vehicle.

### SUMMARY OF THE INVENTION

According to one aspect of the invention, a bolt retention assembly is provided comprising a first component defining a hole. The hole has a threaded bore defining a bore diameter and a counter-bore defining a counter-bore diameter greater than the bore diameter. The threaded bore and counter-bore define a relief therebetween. A bolt having a shank portion and a threaded portion extends through the first component wherein the threaded portion is threadingly engageable with the threaded bore and abuttable with the relief to prevent the bolt from being removed from the hole after the threaded portion is rotatably threaded past the threaded bore.

According to another aspect of the invention there is provided, a method of retaining a bolt having a threaded portion, a shank and a head to a first component having a hole extending therethrough from a first surface to a second surface wherein the hole defines a bore and a counter-bore coaxial therewith and defining a relief therebetween. The method comprises the step of rotatably driving the bolt through the bore such that the bolt is held loosely at the shank portion between the bore and counter-bore wherein the bolt is retained coaxially in one direction by engagement between the head and the first surface of the component and an opposite direction by engagement between the threaded portion and the relief.

### BRIEF DESCRIPTION OF THE DRAWINGS

Advantages of the present invention will be readily appreciated as the same becomes better understood by reference to the following detailed description when considered in connection with the accompanying drawings wherein:

FIG. 1 is a side view of a fastener according to one embodiment of the invention;

FIG. 2 is a side view of the fastener pre-installed on a first component, partially cut away, of an assembly according to one embodiment of the invention;

FIG. 3 is a side view of the fastener pre-installed on the first component, partially cut away, of the assembly according to an alternative embodiment of the invention;

FIG. 4 is a side view of the fastener retaining the first component to a second component of the assembly, partially cut away;

FIG. 5 is a partially cut-away perspective view of a coolant pump including the fastener for assembly to an internal combustion engine; and

FIG. 6 is a partially cut-away perspective view of the coolant pump assembled to the internal combustion engine by the fastener.

### DETAILED DESCRIPTION OF THE PREFERRED EMBODIMENTS

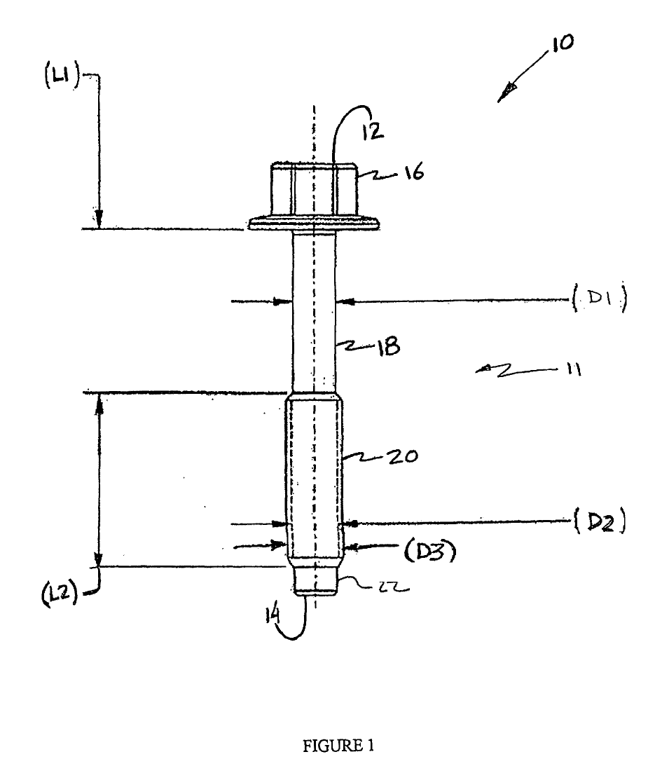

Referring to FIG. 1, a bolt or threaded fastener is generally shown at 10. The bolt 10 includes a body 11 that is generally cylindrical extending between first 12 and second 14 ends. The bolt 10 includes a head 16 adapted for receiving a tool used to rotatably drive the bolt 10 with a torque wrench or similar tool during assembly. The head 16 is fixedly secured to or formed at the first end 12 as is typically hexagon-shaped.

The body 11 of the bolt 10 includes a shank portion 18 adjacent and extending from the first end 12 and a threaded portion 20 extending axially between the shank portion 18 and the second end 14 of the body 11. The shank portion 18 extends axially along a length L1 and has an outer shank diameter D1. The threaded portion 20 extends axially along a length L2. The threaded portion 20 has a minor outer diameter D2, and an outer thread diameter D3 which is greater than the minor outer diameter D2. The minor outer diameter D2 is slightly greater than the outer shank diameter D1 of the shank portion 18. The threaded portion 20 may extend completely to the second end 14 of the body 11 or end spaced from the end 14 as shown in FIG. 1. FIG. 1 includes a further extension 22 of the shank portion 18 from the termination of the threaded portion 20 to a slightly tapered second end 14.

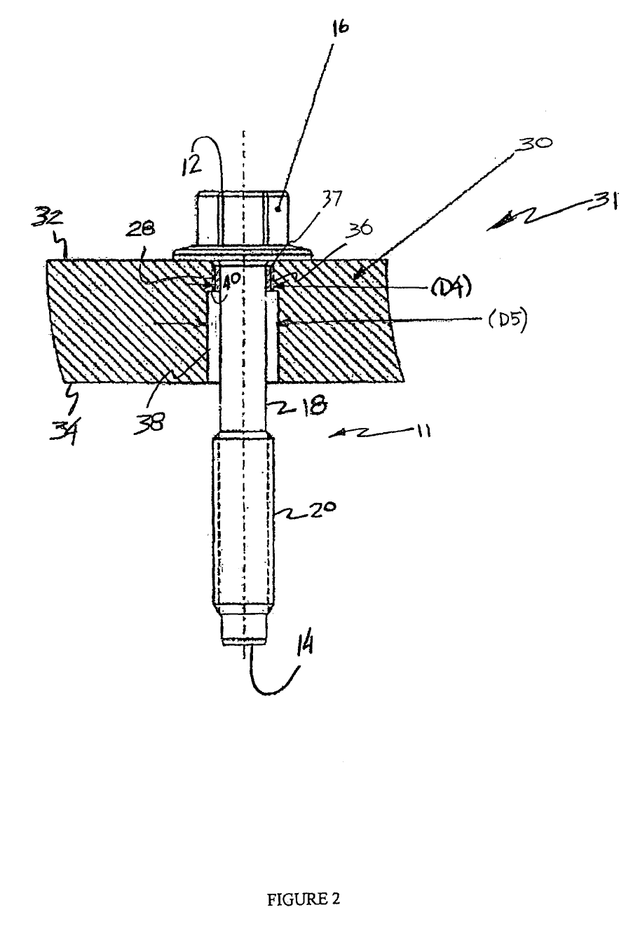

Referring to FIG. 2, the bolt 10 is inserted into a first hole 28 in a first component 30 that extends all the way therethrough. The first component 30 and the bolt 10 define a bolt retention assembly 31. The first component 30 includes first 32 and second 34 surfaces. While not necessary, the first 32 and second 34 surfaces are parallel. The first hole 28 includes a first bore 36 extending inwardly from the first surface 32 through a portion of the first component 30. The first bore 36 includes internal threads 37 for engaging the threaded portion 20 of the bolt 10. Therefore, the first bore 36 has a minor inner diameter D4 smaller than the outer thread diameter D3 of the threaded portion 20. The minor inner diameter D4 of the first bore 36 is slightly greater than the outer shank diameter D1 to allow the shank portion 18 to slide axially therethrough.

The first hole 28 also includes a first counter-bore 38 extending from the second surface 34 into the first component 30 to the first bore 36. The first bore 36 and the first counter-bore 38 are coaxial. The first counter-bore 38 has a diameter D5 greater than the minor inner diameter D4 of the first bore 36 and the outer thread diameter D3. A relief 40 is formed in the first component 30 due to the differences in diameters between the first bore 36 and the first counter-bore 38.

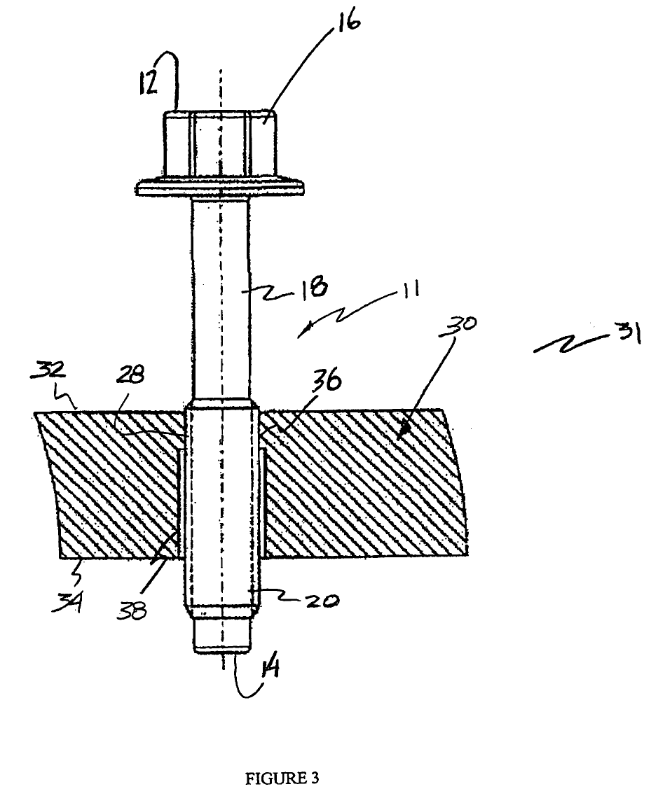

In operation, the bolt 10 is inserted into the first bore 36 at the first surface 32 and is rotatably driven with a torque wrench or similar tool to cause threaded engagement between the threaded portion 20 of the bolt 10 and the first bore 38, as shown in FIG. 3. By continuing the threading of the bolt 10 and the first bore 36, the bolt 10 is drawn or displaced axially toward the second surface 34. The threaded portion 20 is driven past the first bore 36 such that the shank portion 18 is held radially and generally loosely therein, in a trapped condition, allowing the bolt 10 freedom of movement relative to the first component 30 without the bolt 10 being removed from the first hole 28. If the head 16 moves away from the first surface 32, the threaded portion 20 of the bolt 10 abuts the relief 40 preventing continued removal of the bolt 10 from the first hole 28. The axial movement or float of the bolt 10 is limited by engagement between the head 16 and the first surface 34 and between the threaded portion 20 and the relief 40. In this manner, the bolt 10 is retained on the first component 30 to facilitate shipment and handling without loss of the bolt 10.

Alternatively, the bolt 10 may be installed in the first component 30 by leaving the threaded portion 20 of the bolt 10 engaged with the first bore 36, as shown in FIG. 3. The bolt 10 is held or retained in a fixed position by threaded engagement between the threaded portion 20 and the first bore 36 to form the bolt retention assembly 31.

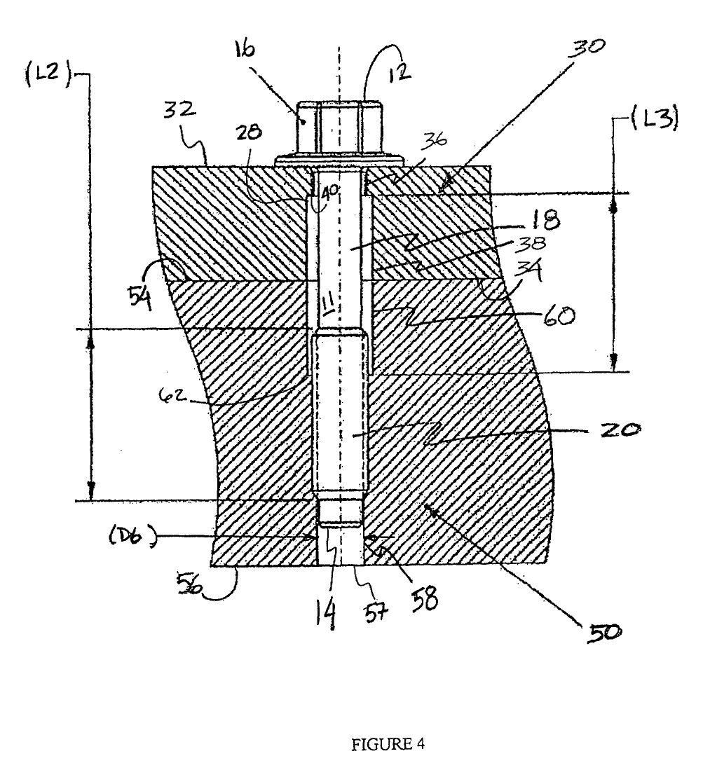

Referring to FIG. 4, a second component 50 extends between an upper surface 54 and a lower surface 56. A second hole 57 extends through the second component 50. The second hole 57 defines a second bore 58 that is formed in the lower surface 56 and extends axially through a portion of the second component 50. The second bore 58 includes internal threads defining a second bore diameter for engaging the threaded portion 20 of the fastener 10. A second counter-bore 60 is formed in the second component 50 extending down from the upper surface 54 to the second bore 58. The second counter-bore 60 defines a diameter D6 greater than the second bore diameter and the outer thread diameter D3 for allowing the threaded portion 20 to move therepast without engagement therewith. The second counterbore 60 is aligned coaxially with the second bore 58. A second relief 62 is similarly formed due to the change in diameter between the second bore 58 and second counter-bore 60.

The first component 30 can be any one of the conventional components or accessories that are mounted to the vehicle engine. Such components or accessories include coolant pumps, tensioners, idler, fan driver, power steering pumps and air conditioning compressors.

During assembly of the first 30 and second 50 components, the bolt 10 is inserted into the first hole 28 and threaded within the first bore 36 to create the bolt retention assembly 31. When the second component 50 is to be secure to the bolt retention assembly 31, the first 28 and second 57 holes are aligned generally axially. The second surface 34 of the first component 30 and the upper surface 54 of the second component 50 are arranged in abutting relation. The second end 14 of the bolt 10 is inserted through the second counter-bore 60 and into the second bore 58. The bolt 10 is rotatably driven with a torque wrench or similar tool to cause threaded engagement between the threaded portion 20 of the bolt 10 and the second bore 58. The bolt 10 is driven until the head 16 locates against the first surface 32 of the first component 30. With the head 16 located against the first surface 32 and the threaded portion 20 engaged with the second bore 58, continued driving of the bolt 10 creates a tensile stress in the bolt 10 and a compressive stress in the first 30 and second 50 components, commonly referred to as clamping force or load.

Still referring to FIG. 4, the first 38 and second 60 counter-bores extend coaxially along a combined length L3. Preferably the combined length L3 of the first 38 and second 60 counter-bores is greater than the length L2 of the threaded portion 20 to ensure that the threaded portion 20 is not at the same time threadingly engaged with the first 36 and second 58 bores.

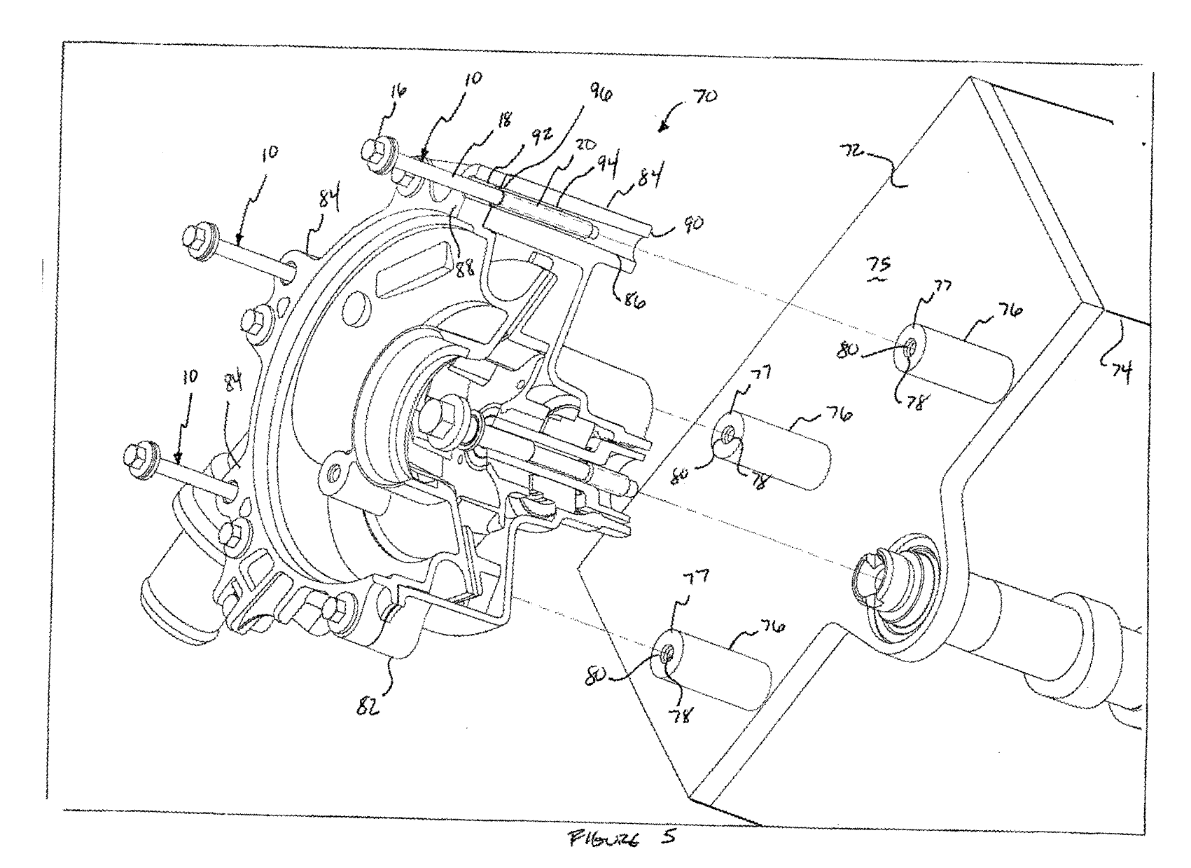

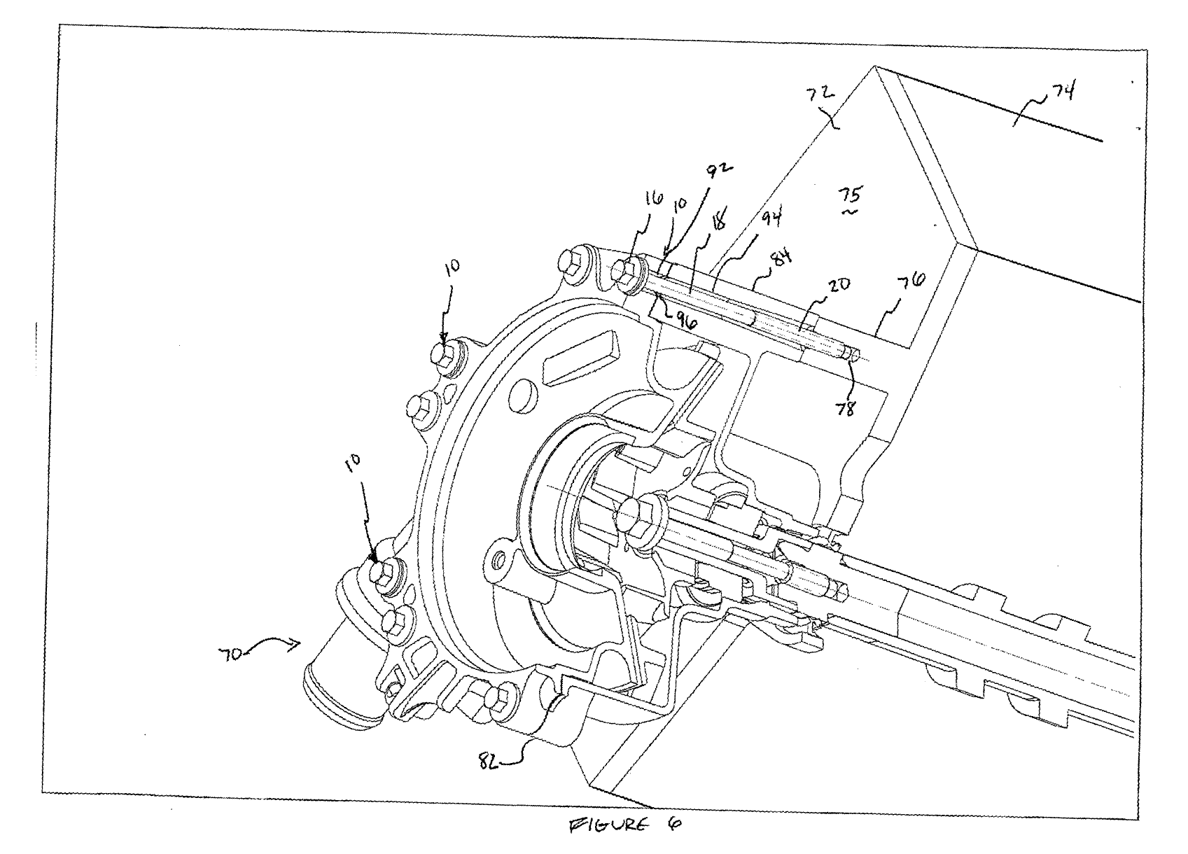

Referring now to FIGS. 5 and 6, an example of the present invention is illustrated. In this example, the bolt 10 is shown retained to a coolant pump 70 for assembly to a mounting portion 72 of an internal combustion engine 74. The coolant pump 70 defines the first component 30 for carrying or retaining a plurality of bolts 10 during shipping, handling and assembly. The engine 74, and specifically the mounting portion 72 of the engine 74, defines the second component 50 to which the coolant pump 70 is to be assembled via the bolts 10.

The mounting portion 72 includes a base plate 75 and a plurality of raised or projecting, cylindrical bosses 76 projecting axially from the base plate 75 to a distal end 77. Each boss 76 defines a bore 78 therethrough for receiving a corresponding bolt 10. The bore 78 of the each boss 76 has internal threads 80 for mating engagement with threads on the threaded portion 20 of the bolt 10 received therein. It should be appreciated that each boss 76 may include a threaded bore 78 and a non-threaded counter-bore as exemplified in the embodiment of FIGS. 1-4 or may be threaded throughout.

The coolant pump 70 includes a housing 82 supporting a plurality of similar cylindrical bosses 84 for axial alignment with the bosses 76 of the engine 74. Each boss 84 of the coolant pump 70 includes a through-hole 86 extending axially between a first end 88 and a second end 90 thereof. Each through-hole 86 includes a bore 92, having internal threads, and a counter-bore 94 with a relief 96 formed in the transition therebetween. The threads of the bore 92 threadingly engage with the threads of the threaded portion 20 of the bolt 10 to secure the bolt 10 to the coolant pump 70. The diameter of the counter-bore 94 is greater than the diameter of the threaded portion 20 of the bolt 10 whereby the bolt 10 is free to move axially within the through-hole 86 once the threaded portion 20 threads completely through the threads of the bore 92. However, the diameter of the bore 92 is less than the diameter of the threaded portion 20 and the head 16 of the bolt 10 to retain the bolt 10 within the boss 84. That is, the portion of the boss 84 defined by the threaded bore 92 is captured between the head 16 and the threaded portion 20 of the bolt 10 once the threaded portion 20 passes into the portion of the boss 84 defined by the counter-bore 94.

The complete description and function of the coolant pump 70 is further discussed in U.S. Pat. No. 6,588,381, issued on Jul. 8, 2003, and the entirety of which is incorporated herein by reference.

In assembly, a bolt 10 is aligned with each through-hole 86 of the coolant pump 70 and rotatably driven with a torque wrench or similar tool to cause threaded engagement between the threaded portion 20 of the bolt 10 and the threaded bore 92 of the boss 84. By continuing the threading of the bolt 10 in the bore 92, the bolt 10 is drawn axially toward the second end 90 of the boss 84. The threaded portion 20 is driven past the bore 92 such that the shank portion 18 is held radially and generally loosely therein, in a trapped condition, allowing the bolt 10 to move freely axially between the head 16 and the threaded portion 20 without being removed from the boss 84.

The coolant pump 70 may then be assembled to the engine 74 by aligning the bosses 84 of the pump 70 with the axially corresponding bosses 76 on the mounting portion 72 of the engine 74. The bolts 10 are axially received within the bore 78 of the bosses 76 for engagement between the threaded portion 20 of the bolt 10 and the threads 80 of the bore 78. With the head 16 located against the first end 88 of the boss 84 and the threaded portion 20 engaged with the threads of the bore 78, continued rotational driving of the bolt 10 creates tensile stress in the bolt 10 and a compressive stress between the coolant pump 70 and mounting portion 72 to clamp and fixedly secure the coolant pump 70 to the engine 74.

The invention has been described in an illustrative manner, and it is to be understood that the terminology, which has been used, is intended to be in the nature of words of description rather than of limitation. Many modification and variations of the present invention are possible in light of the above teachings. It is, therefore, to be understood that within the scope of the appended claims, the invention may be practiced other than as specifically described.

What is claimed is:

1. A bolt retention assembly comprising:
a first component defining a hole, said hole having a threaded bore defining a bore diameter and a counter-bore defining a counter-bore diameter greater than said bore diameter, said threaded bore and said counter-bore defining a relief therebetween; and
a bolt having a shank portion and a threaded portion extending through said first component, said threaded portion threadingly engageable with said threaded bore and abuttable with said relief preventing said bolt from being removed from said hole after said threaded portion is rotatably threaded past said threaded bore.

2. A bolt retention assembly as set forth in claim 1 wherein said bolt further includes a head formed on said shank portion opposite said threaded portion for preventing said bolt from passing completely through said hole after said threaded portion is rotatably threaded past said threaded bore.

3. A bolt retention assembly as set forth in claim 2 wherein said shank portion defines an outer shank diameter and said bore diameter is greater than said outer shank diameter to allow said shank portion to slide therethrough between said head and said threaded portion.

4. A bolt retention assembly as set forth in claim 3 wherein said threaded portion defines a minor outer diameter and an outer thread diameter greater than said minor outer diameter and said shank diameter, and said counter bore diameter is greater than said outer thread diameter to allow said threaded portion to move axially through said counter-bore.

5. A bolt retention assembly as set forth in claim 4 wherein said first component is a coolant pump for assembly to an engine.

6. A bolt retention assembly as set forth in claim 5 wherein said coolant pump includes a housing having a plurality of bosses defining through holes extending axially between first and second ends.

7. A bolt retention assembly as set forth in claim 6 wherein said through hole includes said threaded bore for threadingly engaging with said threaded portion of said bolt and said counter-bore extending from said threaded bore to said second end for freely receiving said threaded portion therethrough.

8. A bolt retention assembly as set forth in claim 7 further including a second component for mounting to said first component, said second component having a second hole axially aligned with said hole of said first component.

9. A bolt retention assembly as set forth in claim 8 wherein said second hole includes a threaded bore defining a second bore diameter and threadingly engageable with said threaded portion of said bolt to clamp said second component to said first component.

10. A bolt retention assembly as set forth in claim 9 wherein said second hole includes a counter-bore defining a second counter-bore diameter greater than said second bore diameter, said bore and counter-bore of said second component defining a relief therebeween.

11. A bolt retention assembly as set forth in claim 10 wherein said second component is a mounting portion of an engine and wherein said mounting portion includes a plurality of bosses having through-holes defined by said second bore and said second counter-bore.

12. A method of retaining a bolt having a threaded portion, a shank and a head to a first component having a hole extending therethrough from a first surface to a second surface wherein the hole defines a bore and a counter-bore coaxial therewith and defining a relief therebetween, the method comprising the step of rotatably driving the bolt through the bore such that the bolt is held loosely at the shank portion between the bore and counter-bore wherein the bolt is retained coaxially in one direction by engagement between the head and the first surface of the component and an opposite direction by engagement between the threaded portion and the relief.
